(19) United States
(12) Patent Application Publication
(10) Pub. No.: US 2010/0184441 A1
(43) Pub. Date: Jul. 22, 2010

(54) TRANSMISSION OF USEFUL AND CONTROL INFORMATION DURING SOFT HANDOVER

(76) Inventors: Volker Breuer, Botzow (DE); Meik Kottkamp, Munchen (DE); Thomas Ulrich, Bad Durkheim (DE); Alexander Vesely, Feldbach (AT)

Correspondence Address: STAAS & HALSEY LLP, SUITE 700, 1201 NEW YORK AVENUE, N.W., WASHINGTON, DC, 20005, US

(21) Appl. No.: 12/312,333

(22) PCT Filed: Oct. 23, 2007
(86) PCT No.: PCT/EP2007/061346

§ 371 Date: Mar. 24, 2010

(30) Foreign Application Priority Data
Nov. 6, 2006 (EP) 06023065.3

(51) Int. Cl. H04W 36/00

(52) U.S. Cl. 455/442

(57) ABSTRACT

First and second network-based radio stations receive information content, i.e., useful information, transmitted by a subscriber station and control information relating to the useful information. The first network-based radio station and the second network-based radio station transmit the control information, but only the first network-based radio station transmits the useful information.

### CROSS REFERENCE TO RELATED APPLICATIONS

This application is the U.S. national stage of International Application No. PCT/EP2007/061346, filed Oct. 23, 2007 and claims the benefit thereof. The International Application claims the benefits of European Application No. 06023065.3 filed on Nov. 6, 2006, both applications are incorporated by reference herein in their entirety.

### BACKGROUND

Described below is a method for communication by radio, in which a first and a second network-end radio station receive information content, i.e. useful information, sent by a subscriber station and control information relating to the useful information.

In radio communication systems, messages, for example containing voice information, picture information, video information, SMS (Short Message Service), MMS (Multimedia Messaging Service) or other data, are transmitted between the sending and the receiving station via a radio interface using electromagnetic waves. In this context, depending on the specific refinement of the radio communication system, the stations may be various kinds of subscriber stations or network-end radio stations, such as repeaters, radio access points or base stations. In a mobile radio communication system, at least some of the subscriber stations are mobile radio stations. The electromagnetic waves are emitted at carrier frequencies which are in the frequency band provided for the respective system.

Current mobile radio communication systems are often in the form of cellular systems, e.g. based on the GSM (Global System for Mobile Communications) or UMTS (Universal Mobile Telecommunications System) standard, with a network infrastructure including base stations, devices for monitoring and controlling the base stations and further network-end devices, for example. Another example is wireless access broadband networks, for example based on IEEE 802.16. Future mobile radio communication systems may be, by way of example, further developments of UMTS, referred to as LTE (Long Term Evolution), or fourth-generation systems, and also ad-hoc networks. Apart from extensively organized (superlocal) cellular, hierarchic radio networks, there are wireless local area networks (WLANs) with a radio coverage area which is usually physically limited to a much greater degree. Examples of different standards for WLANs are HiperLAN, DECT, IEEE 802.11, Bluetooth and WATM.

If circuit switching is used, a subscriber station is allocated a constant bandwidth or radio resources which allow transmission at a constant data rate, for exclusive use. One example of circuit-switched radio resources in UMTS are the dedicated channels which correspond to one or more codes allocated to a particular subscriber station constantly. By contrast, packet switching involves the use of radio channels which are split among the subscriber stations (shared channels). These channels are allocated to a subscriber station only for a short time for the purpose of sending or receiving a packet. An example of a service using packet-switched resources in UMTS is HSDPA (High Speed Downlink Packet Access), which involves a subscriber station being allocated radio resources for receiving data packets, or EDCH (Enhanced Dedicated Channel) or HSUPA (High Speed Uplink Packet Access), which involves a subscriber station being allocated radio resources for sending data packets. Radio resources from a shared channel or packet-switched radio resources are therefore not allocated to a subscriber station, in contrast to circuit-switched radio resources, if the subscriber station currently has no messages to send or receive.

If a subscriber station is on the border between two radio cells, it is often necessary to change the subscriber station's connection from one network-end radio station to another network-end radio station. In this case, a distinction is drawn between a hard handover, in which the connection to the old network-end radio station is cleared down before a connection to the new network-end radio station is set up. In the case of soft handover, on the other hand, the subscriber station is connected to the old and the new network-end radio station during a particular period of time. This means that the subscriber station sends messages to both network-end radio stations and also receives messages from both network-end radio stations during this period of time. Soft handovers are used in UMTS, for example.

### SUMMARY

An aspect is a method for communication by radio and also a radio communication system which allow efficient execution of a handover.

In the method for communication by radio, a first network-end radio station and a second network-end radio station receive useful information sent by a subscriber station and control information relating to the useful information. The first network-end radio station and the second network-end radio station forward the control information. Only the first network-end radio station forwards the useful information.

A subscriber station therefore sends both useful information and control information. In this case, there is a relation between the control information and the useful information. On the basis of this relation, the control information can indicate parameters for the transmission of the useful information, for example, or can describe the processing of the useful information that is carried out at the transmitter end, or can prescribe processing of the useful information that is to be carried out at the receiver end. The control information may be in a form such that knowledge thereof is essential for understanding the useful information.

The two network-end radio stations both receive the useful information and control information sent by the subscriber station. This is possible particularly if the two network-end radio stations are adjacent network-end radio stations, i.e. are network-end radio stations whose radio cells border one another. The useful information and control information is received by the two network-end radio stations approximately at the same time; different reception times may result from various signal propagation times between the subscriber station and the first network-end radio station, on the one hand, and the subscriber station and the second network-end radio station, on the other.

Received information is forwarded by the network-end radio stations. This forwarding is to one or more other network-end devices for further processing and/or forwarding. Prior to the forwarding by the network-end radio stations, the information may be processed by the first and/or the second network-end radio station. In terms of forwarding by the network-end radio stations, the useful information and the control information is handled differently: while the control information is forwarded by both network-end radio stations, the forwarding of the useful information is limited to forwarding by one of the two network-end radio stations. The twofold forwarding of the control information may be to the same network-end device, which means that this device can process the twice received control information jointly.

Besides the first and second network-end radio stations, there may be further network-end radio stations involved in the method. By way of example, it is possible for the control information to be forwarded by three network-end radio stations, while the useful information is forwarded only by one or two of the three network-end radio stations.

In one development, the first and second network-end radio stations forward the control information to a first network-end device and the first network-end radio station forwards the useful information to the first network-end device too. A network-end device is therefore used which receives both the useful information and the control information from the subscriber station through forwarding.

In line with another development, the first and second network-end radio stations forward the control information to a first network-end device, and the first network-end radio station forwards the useful information to a second network-end device. In this case, the first network-end device receives only the control information, but not the useful information. It is advantageous if the second network-end device is a device which receives the control information from the first network-end device through forwarding. In this case, the control information is transmitted to the second network-end device by an indirect route running via the first network-end device. This indirect route can be chosen for the reason that the first network-end device performs editing on the control information, for example.

It is particularly advantageous if the first network-end device sends the first and/or the second network-end radio station instructions, the instructions relating to the forwarding of the useful information. By way of example, the instructions may indicate which network-end radio station is intended to forward the useful information, or to which network-end device the useful information is to be forwarded. The first network-end device makes the decision about the content of the instructions. This is particularly advantageous if the first network-end device is the receiver of the forwarded control information, which means that the received control information can be used as a decision criterion by the first network-end device.

In line with one refinement, the first network-end device combines the control information received by the first network-end radio station with the control information received by the second network-end radio station and forwards the resulting control information. This combination can be effected in various ways, for example by comparing the two pieces of control information and selecting the better one.

The first network-end device may be part of the first or of the second network-end radio station. In this case, the first network-end radio station forwards the control information to the second network-end radio station, or vice versa. In this case, the relevant network-end radio station has both the control information which it has received and the control information which the other network-end radio station has received available.

It is advantageous if the first network-end radio station receives the useful information at higher reception power than the second network-end radio station. This is suitable because it ensures that the useful information is forwarded with higher quality than if the second network-end radio station were to forward the useful information. The reception power can be used as a criterion for deciding which network-end radio station needs to forward the useful information.

The forwarding of the useful information may be changed. It is thus possible that, at a later time, the first and second network-end radio stations forward the control information, while only the second network-end radio station forwards the useful information. In this case, the task of forwarding the useful information has moved from the first network-end radio station to the second network-end radio station. Alternatively, at a later or earlier time, the first and second network-end radio stations can forward the control information, while the first and second network-end radio stations forward the useful information. In this case, the useful information is forwarded occasionally by only one of the two network-end radio stations, and occasionally by both network-end radio stations.

In one refinement, the useful information is transmitted to the first and second network-end radio stations using an uplink channel which is common to a plurality of subscriber stations. A shared channel of this kind is available not exclusively within the meaning of a dedicated channel to just one subscriber station. Rather, it is occasionally allocated to individual subscriber stations for the purpose of sending individual information packets.

The method can be carried out in relation to a plurality of subscriber stations. In this case, only the first network-end radio station forwards useful information received from one or more first subscriber stations, and only the second network-end radio station forwards useful information received from one or more second subscriber stations. Carrying out the method in relation to a plurality of subscriber stations means that a plurality of subscriber stations respectively send useful information and control information. The first and second network-end radio stations receive the useful information and control information, and both network-end radio stations forward the control information. By contrast, the useful information is forwarded only by one of the two network-end radio stations. In this case, the network-end radio station forwarding the useful information may be a different one from subscriber station to subscriber station.

It is particularly advantageous if the first and second network-end radio stations receive the useful information from the first subscriber stations within a first period of time and receive the useful information from the second subscriber stations within a second period of time. A block of successive pieces of useful information which need to be forwarded by the first network-end radio station is therefore received, followed or preceded by a block of successive pieces of useful information which need to be forwarded by the second network-end radio station. The different blocks may follow one another directly or may be separated by a guard time in order to avoid overlaps.

The radio communication system includes at least a first and a second network-end radio station. The first and second network-end radio stations are able to receive useful information sent by a subscriber station and control information relating to the useful information, and also forward the control information. However, only the first network-end radio station forwards the useful information.

The radio communication system is particularly suitable for carrying out the method, this also being able to relate to the refinements and developments. To this end, it may include components for controlling the forwarding of the useful information and control information.

### BRIEF DESCRIPTION OF THE DRAWINGS

These and other aspects and advantages will become more apparent and more readily appreciated from the following description of an exemplary embodiment, taken in conjunction with the accompanying drawings of which:

FIG. 1 is a block diagram of detail from a radio communication system with a first connection configuration,

FIG. 2 is a block diagram of a second connection configuration,

FIG. 3 is a block diagram of a third connection configuration,

FIG. 4 is a block diagram of a fourth connection configuration, and

FIG. 5 is an information transmission diagram for forwarding of information from a plurality of subscriber stations.

### DETAILED DESCRIPTION OF THE PREFERRED EMBODIMENT

Reference will now be made in detail to exemplary embodiments illustrated in the accompanying drawings, wherein like reference numerals refer to like elements throughout.

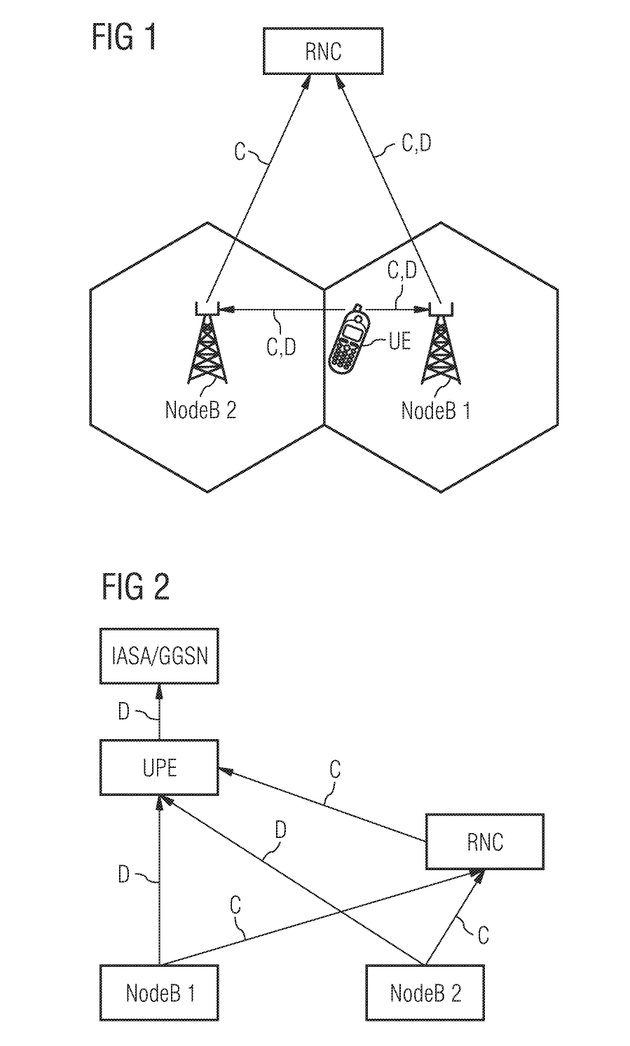

The method can be applied to various kinds of radio communication systems. The specific example considered below is a mobile radio communication system based on the UMTS standard. However, the method is not limited to such systems; in particular, the mobile radio communication system under consideration may also be a system based on a further development of UMTS, referred to as LTE (Long Term Evolution). The detail from the mobile radio communication system which is shown in FIG. 1 shows the radio cell of the network-end radio station NodeB 1, and also the radio cell of the adjacent network-end radio station NodeB 2. The network-end radio stations NodeB 1 and NodeB 2 respectively communicate with subscriber stations, for example with the subscriber station UE. An interface referred to as lub in UMTS connects the network-end radio stations NodeB 1 and NodeB 2 to the control device RNC (Radio Network Controller), which is responsible for controlling and monitoring radio links, e.g. for managing codes and cell changes (handover). Information can be transmitted between the network-end radio stations NodeB 1 and NodeB 2 and the control device RNC using ATM; in UMTS, the use of IP has also been standardized for this since Release 5. The control device RNC is usually responsible for a multiplicity of network-end radio stations. For reasons of clarity, further radio cells, subscriber stations and network-end devices are not shown in FIG. 1.

If the subscriber station UE is at the cell border between radio cells of different network-end radio stations, as shown in FIG. 1, for example, what is known as soft handover mode is used for sending messages in the uplink, i.e. from the subscriber station UE to network-end radio stations. Soft handover is understood to mean that a plurality of network-end radio stations receive messages sent by the subscriber station UE and forward them. Subsequently to this forwarding, the messages forwarded by the various network-end radio stations are combined, subsequently referred to as soft combining. This increases the network-end quality of the messages from the subscriber station. This course of action is advantageous for subscriber stations at the cell edge, since there is usually a poor radio link between a subscriber station situated at the cell edge and the network-end radio stations of the respective radio cell or of an adjacent radio cell. It is subsequently assumed that it has been decided that the soft handover mode will be used for the subscriber station UE.

The situation considered is that the subscriber station UE is using the service EDCH (Enhanced Dedicated Channel), also referred to as HSUPA (High Speed Uplink Packet Access). This is a transmission method for UMTS which is intended to allow high data rates in the uplink. This provides a complementary service for HSDPA (High Speed Downlink Packet Access). EDCH is a packet-switched service, and therefore an EDCH code is available to a subscriber station not permanently but rather only occasionally for the purpose of sending information in packets; the EDCH channels are therefore in the form of shared channels. The physical channels for transmitting the useful information are called EDPDCH (Enhanced Dedicated Physical Data Channel); those for transmitting control information are called EDPCCH (Enhanced Dedicated Physical Control Channel). In this case, the control information from the EDPCCH relates to the useful information from the EDPDCH, e.g. it includes a pilot or training sequence and/or a transport format combination indicator. The control information from the EDPCCH therefore contains information which is required at the receiver end in order to process the useful information from the EDPDCH. Without the content of the control information, the useful information cannot be understood correctly at the receiver end.

In the situation shown in FIG. 1, the subscriber station UE currently using the service EDCH sends the control information C, and also the useful information D, with both the control information C and the useful information D being received by the two network-end radio stations NodeB 1 and NodeB 2. On account of the explained importance of the control information C, this information is emitted with a high level of error protection encoding and at high transmission power by the subscriber station UE. The quality of the control information C is also increased by virtue of the control device RNC performing soft combining for the control information C received by the network-end radio station NodeB 1 and the control information C received by the network-end radio station NodeB 2. This is because both network-end radio stations NodeB 1 and NodeB 2 forward the control information C to the control device RNC.

In contrast to the control information C, the useful information D is not forwarded by both network-end radio stations NodeB 1 and NodeB 2. Rather, only the network-end radio station NodeB 1 forwards the useful information D. The control information C and the useful information D is therefore handled differently in terms of forwarding and hence also in terms of soft combining.

This course of action has the advantage that less transmission capacity is needed on the interface between the network-end radio stations NodeB 1 and NodeB 2 and the control device RNC. The provision of the transmission capacity on this interface is a significant portion of the OPEX (Operation Expenditures) of a radio communication system. It is therefore worthwhile to reduce the volume of data via this interface. The soft combining of the control information C is nevertheless not dispensed with, since firstly the control information C is of great importance, as explained above, and secondly the extent of the control information C is only small, which means that the loading on the interface under consideration as a result of the control information C is insignificant.

To be able to obtain a high quality for the useful information D which is present at the network end despite the useful information D being forwarded only once, it is advantageous if only short messages are chosen for transmitting the useful information D. Thus, Release 6 of the UMTS standard allows 2-ms TTIs (TTI: Transmission Time Interval) to be used for EDCH instead of 10-ms TTIs. Short messages reduce the likelihood of collisions between messages from different subscriber stations.

The decision that the network-end radio station NodeB 1 undertakes the forwarding of the useful information D, but not the network-end radio station NodeB 2 is made by the control device RNC. The decision parameter used may be the quality of the control information C received by the network-end radio stations NodeB 1 and NodeB 2. This is because if one network-end radio station receives the control information C at higher reception power than another network-end radio station, this also applies to the useful information D. By way of example, it is possible to use a threshold value with which the reception powers are compared. The control device RNC informs the network-end radio stations NodeB 1 and NodeB 2 about which network-end radio station needs to forward the useful information D.

The useful information D is therefore forwarded alternatively by the network-end radio station NodeB 1 or the network-end radio station NodeB 2. As a departure from this, it is occasionally or for some subscriber stations possible for both network-end radio stations NodeB 1 and NodeB 2 to forward the useful information D. If the subscriber station UE moves from the radio cell of the network-end radio station NodeB 1 to the radio cell of the network-end radio station NodeB 2, for example, then it is possible for the useful information D to be forwarded by the network-end radio station NodeB 1 first of all, then by both network-end radio stations NodeB 1 and NodeB 2, and then by the network-end radio station NodeB 2. By contrast, the control information C is unchangedly forwarded by both network-end radio stations NodeB 1 and NodeB 2. In this case, the decision to change is made by the control device RNC, as explained above.

FIG. 2 shows an alternative configuration of the radio communication system. In this case, as explained with reference to FIG. 1, the control information C is forwarded by the network-end radio stations NodeB 1 and NodeB 2 to the control device RNC, where the soft combining takes place. By contrast, the useful information D is forwarded not to the control device RNC but rather to the device UPE (User Plane Entity), which forwards the useful information D to further network-end devices IASA/GGSN (IASA: Inter Access System Anchor, an anchor point which remains constant even when a connection changes to a non-3GPP system, such as a WLAN) (GGSN: Gateway GPRS Support Node). The forwarding of the useful information D is controlled by the control device RNC, which, as explained with reference to FIG. 1, determines which network-end radio station is to perform the forwarding.

The device UPE is a higher-level device within the network architecture than the control device RNC, which means that dispensing with forwarding the useful information D using the control device RNC allows faster network-end processing of the useful information D. Network architectures using the device UPE are described in 3GPP TS 23.882, for example.

As explained with reference to FIG. 1, the control device RNC decides which network-end radio station NodeB 1 or NodeB 2 or else NodeB 1 and NodeB 2 needs to forward the useful information D and notifies the network-end radio stations NodeB 1 and NodeB 2 of this. Control information C which has already been subjected to soft combining is forwarded to the device UPE by the control device RNC, since the device UPE needs the control information C in order to process the useful information D.

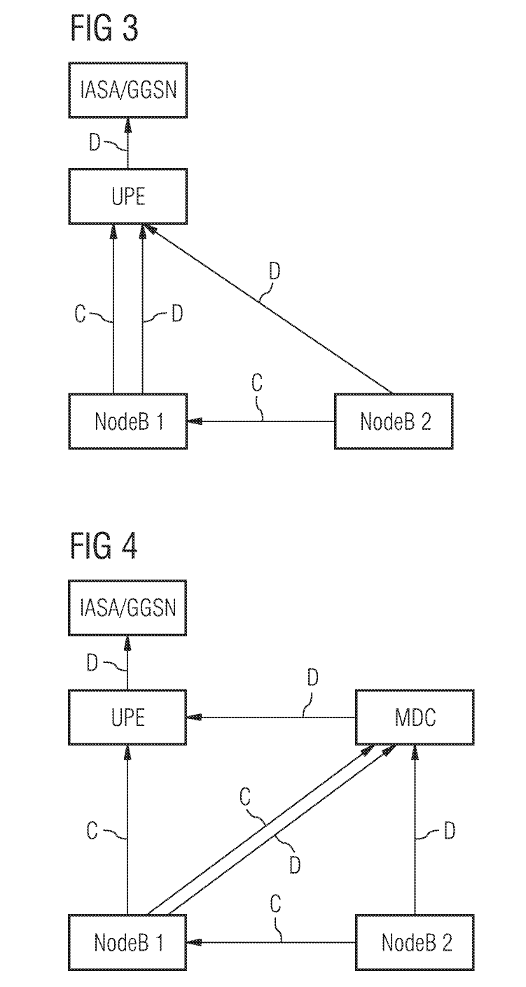

FIG. 3 shows a further configuration, with the functionality of the control device RNC in FIG. 2 being provided by the network-end radio station NodeB 1. In this case, the network-end radio station NodeB 2 sends the control information C that it has received to the network-end radio station NodeB 1, which combines this information with the control information C that it has received. The useful information is sent alternatively via the network-end radio station NodeB 1 or NodeB 2, or else by both network-end radio stations NodeB 1 and NodeB 2, under the control of the network-end radio station NodeB 1.

A further alternative configuration is shown in FIG. 4. In this case, as in FIG. 3 too, the functionality of the control device RNC in FIG. 2 is undertaken by the network-end radio station NodeB 1. The useful information D is forwarded by the network-end radio stations NodeB 1 and/or NodeB 2 not directly to the device UPE but rather to the device MDC, which forwards the received useful information D to the device UPE. As explained above, the information is forwarded alternatively by the network-end radio station NodeB 1 or NodeB 2. If the useful information D is sent to the device MDC by both network-end radio stations NodeB 1 and NodeB 2, the device MDC performs soft combining for the useful information D and forwards the combined useful information D to the device UPE.

While the method has been explained with reference to the two adjacent network-end radio stations NodeB 1 and NodeB 2, it can also be applied to a larger number of adjacent network-end radio stations. Thus, the control information C can be forwarded by three network-end radio stations, for example, for soft combining, whereas the useful information D is forwarded only by one of the network-end radio stations, or alternatively by two or three of the network-end radio stations.

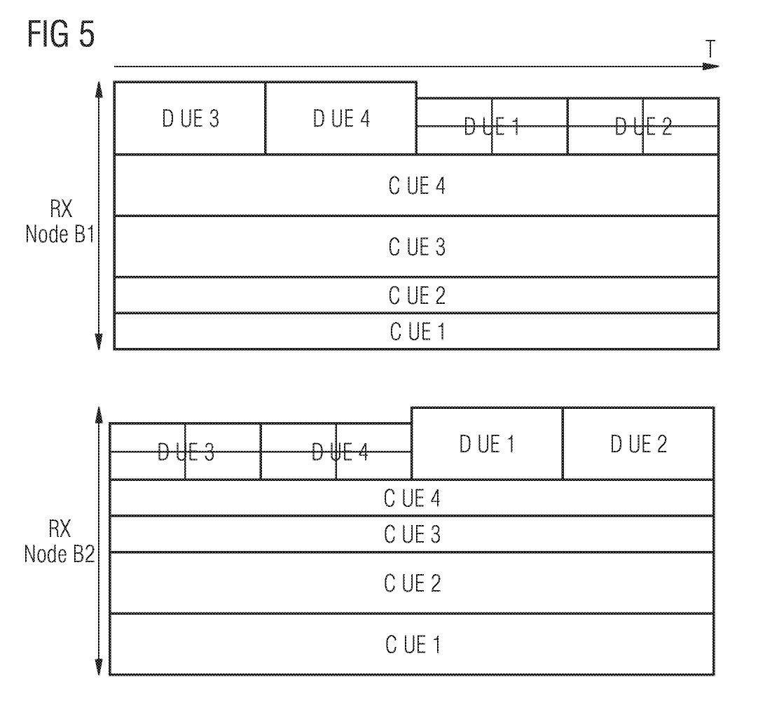

The method can also be applied to a larger number of subscriber stations. FIG. 5 schematically shows the forwarding of useful information D and control information C from the four subscriber stations UE1, UE2, UE3 and UE4. These four subscriber stations UE1, UE2, UE3 and UE4 are currently in soft handover mode in the area between the network-end radio stations NodeB 1 and NodeB 2. The upper part of FIG. 5 shows the reception strength RX of the useful information D and control information C from the four subscriber stations UE1, UE2, UE3 and UE4 in the network-end radio station NodeB 1, and the bottom part shows the reception strength RX of the useful information D and control information C from the four subscriber stations UE1, UE2, UE3 and UE4 in the network-end radio station NodeB 2. The reception strength RX respectively corresponds to the vertical extent of a rectangle. The progression of time T is plotted rightwards. The length of the useful information messages, respectively shown above the control information messages, is shorter than the length of the control information messages.

The network-end radio station NodeB 1 receives the useful information D and control information C from the two subscriber stations UE3 and UE4 at higher reception strength RX than the network-end radio station NodeB 2; the converse applies for the useful information D and control information C from the two subscriber stations UE1 and UE2. Accordingly, it is decided that the network-end radio station NodeB 1 forwards the useful information D from the two subscriber stations UE3 and UE4, while the network-end radio station NodeB 2 forwards the useful information D from the two subscriber stations UE1 and UE2. The unforwarded useful information D is respectively shown as strikethrough text. The control information C from the subscriber stations UE1, UE2, UE3 and UE4 is forwarded by both network-end radio stations NodeB 1 and NodeB 2.

The subscriber stations UE1, UE2, UE3 and UE4 in soft handover mode are controlled by one of the two network-end radio stations NodeB 1 and NodeB 2, i.e. one of the two network-end radio stations NodeB 1 and NodeB 2 sends each of the subscriber stations UE1, UE2, UE3 and UE4 control information relating, by way of example, to the transmission power and transmission times to be applied by subscriber stations UE1, UE2, UE3, UE4. It is subsequently assumed that subscriber stations UE1 and UE2 are controlled by the network-end radio station NodeB 2, and subscriber stations UE3 and UE4 are controlled by the network-end radio station NodeB 1. In respect of their useful information D, subscriber stations UE1, UE2, UE3 and UE4 are scheduled such that those subscriber stations UE3 and UE4 whose useful information D is forwarded by the network-end radio station NodeB 1 are together in time and therefore form a block. The same applies to subscriber stations UE1 and UE2 scheduled by the network-end radio station NodeB 2.

This grouping of subscriber stations is particularly advantageous for asynchronous operation. FIG. 5 shows synchronous operation, i.e. the network-end radio station NodeB 1 receives the useful information D and control information C from the subscriber stations UE3 and UE4, which they schedule, in each case at the start of their time frame, and equally it receives the useful information D and control information C from the subscriber stations UE1 and UE2, which the network-end radio station NodeB 2 schedules, in each case at the start of their time frame. The same applies for the network-end radio station NodeB 2. During asynchronous operation, on the other hand, the time frames of the network-end radio stations NodeB 1 and NodeB 2 are shifted relative to one another. If, in the asynchronous case, no break is observed between the sending of the useful information D from the subscriber station UE4, i.e. the last subscriber station in the block of the network-end radio station NodeB 1, and the sending of the useful information D from the subscriber station UE1, i.e. the first subscriber station in the block of the network-end radio station NodeB 2, then the time shift in the time frames may result in interference between the useful information D from the subscriber station UE4, forwarded by the network-end radio station NodeB 1, and the useful information D from the subscriber station UE1, forwarded by the network-end radio station NodeB 2. To prevent this, the subscriber stations are scheduled for asynchronous operation such that there is a guard period, in which no subscriber station sends useful information D, between the sending of the useful information D by the subscriber station UE4 and the sending of the useful information D by the subscriber station UE1. This guard period should correspond approximately to the synchronization difference between the time frames of the network-end radio stations NodeB 1 and NodeB 2. Since the guard period is required only between the block of the network-end radio station NodeB 1 and the block of the network-end radio station NodeB 2, the grouping of the subscriber stations UE1, UE2, UE3, UE4 increases the utilization of the radio resources.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-13. (canceled)

14. A method for communication by radio, comprising:
receiving, at first and second network-end radio stations, information content sent by a subscriber station and control information relating to the information content;
forwarding the control information from the first and second network-end radio station to a first network-end device; and
forwarding the information content only from the first network-end radio station.

15. The method as claimed in claim 14, wherein the first network-end radio station forwards the information content to the first network-end device.

16. The method as claimed in claim 14, wherein the first network-end radio station forwards the information content to a second network-end device.

17. The method as claimed in claim 16, wherein the first network-end device sends at least one of the first and second network-end radio station instructions in regard to forwarding of the information content.

18. The method as claimed in claim 17, wherein the first network-end device combines the control information received by the first network-end radio station with the control information received by the second network-end radio station and forwards the resulting control information.

19. The method as claimed in claim 18, wherein the first network-end device is part of one of the first and second network-end radio stations.

20. The method as claimed in claim 19, wherein the first network-end radio station receives the information content at higher reception power than the second network-end radio station.

21. The method as claimed in claim 20, further comprising, at a later time:
forwarding the control information from the first and second network-end radio stations; and
forwarding the information content only from the second network-end radio station.

22. The method as claimed in claim 20, further comprising, at a later or earlier time:
forwarding the control information from the first and second network-end radio stations; and
forwarding the information content from the first and second network-end radio stations.

23. The method as claimed in claim 22, wherein the information content is transmitted to the first and second network-end radio stations using an uplink channel common to a plurality of subscriber stations.

24. The method as claimed in claim 22,
wherein the method is carried out in relation to a plurality of subscriber stations, and
wherein only the first network-end radio station forwards information content received from a first set of at least the subscriber station and only the second network-end radio station forwards information content received from a second set of at least one other subscriber station.

25. The method as claimed in claim 24, wherein the first and second network-end radio stations receive the information content from the first set of at least the subscriber station within a first time period and receive the information content from the second set of at least one other subscriber station within a second time period.

26. A radio communication system serving subscriber stations, comprising:
a network-end device; and
first and second network-end radio stations, only said first network-end radio station having first forwarding means for forwarding information content sent by one of the subscriber stations, each of said first and second network-end radio stations having
receiving means for receiving the information content and control information relating to the information content; and
second forwarding means for forwarding the control information to said network-end device.
